(19) United States
(12) Patent Application Publication
(10) Pub. No.: US 2026/0161451 A1
(43) Pub. Date: Jun. 11, 2026

(54) SCHEDULING DEVICE, METHOD, AND PROGRAM

(71) Applicant: NEC Corporation, Tokyo (JP)

(72) Inventor: Yasuharu OKAMOTO, Tokyo (JP)

(21) Appl. No.: 19/180,363

(22) Filed: Apr. 16, 2025

(30) Foreign Application Priority Data
May 9, 2024 (JP) 2024-076254

(51) Int. Cl. G06F 9/48

(52) U.S. Cl. CPC G06F 9/4887; G06F 9/4818

(57) ABSTRACT

A scheduling device includes an input unit configured to receive input of processing times required, for each of multiple jobs in which a first processing by a first system and a second processing by a second system are executed in mutual repetition one or more times, for the first processing and the second processing for each job, and a schedule creation control unit configured to control processing to create a schedule based on the processing times. The schedule creation control unit includes a set creation unit configured to create, among the multiple jobs, a set of jobs that can be processed by the first system without idle time, and a selection unit configured to select one job from among the set of jobs to be executed by the first system.

### CROSS-REFERENCE TO RELATED APPLICATIONS

This application is based upon and claims the benefit of priority from the prior Japanese Patent Application No. 2024-76254, filed May 9, 2024, the entire contents of which are incorporated herein by reference.

### BACKGROUND OF THE INVENTION

The present disclosure relates to a scheduling device, a scheduling method, and a scheduling program for scheduling jobs executed by multiple systems.

A hybrid approach that solves combinatorial optimization problems by integrating multiple techniques has gained attention. A hybrid approach is a technique that solves problems by combining heterogeneous platforms, such as a quantum computer or quantum annealer together with a classical computer.

For example, Patent Literature 1 describes a method for performing a computation task using a quantum on-demand service and a classical service. In the method disclosed in Patent Literature 1, the computation task is decomposed, and the decomposed computation task is distributed to the quantum on-demand service and the classical service for execution.

### PRIOR ART DOCUMENTS

[Patent Literature 1] Japanese Unexamined Patent Application Publication No. 2019-521431

### SUMMARY OF THE INVENTION

While processing by a quantum computer is fast, using quantum computer resources is generally expensive. For example, merely decomposing and executing a computation task in a straightforward manner, as in the method disclosed in Patent Literature 1, makes it difficult to fully operate the quantum on-demand service, potentially failing to make full use of its resources. Thus, when jobs are executed by multiple systems and there is a system that should be preferentially operated among those systems, it is desirable to schedule the jobs so that the system can be operated on a priority basis.

Accordingly, an exemplary object of the present disclosure is to provide a scheduling device, a scheduling method, and a scheduling program that can schedule jobs so as to allow one system among multiple systems to be operated on a priority basis.

The scheduling device according to the present disclosure includes: an input unit configured to receive input of processing times required, for each of multiple jobs in which a first processing by a first system and a second processing by a second system are executed in mutual repetition one or more times, for the first processing and the second processing for each job; and a schedule creation control unit configured to control processing to create a schedule based on the processing times, wherein the schedule creation control unit includes: a set creation unit configured to create, among the multiple jobs, a set of jobs that can be processed by the first system without idle time; and a selection unit configured to select one job from among the set of jobs to be executed by the first system.

The scheduling method according to the present disclosure includes: receiving input of processing times required, for each of multiple jobs in which a first processing by a first system and a second processing by a second system are executed in mutual repetition one or more times, for the first processing and the second processing for each job; based on the processing times, creating, among the multiple jobs, a set of jobs that can be processed by the first system without idle time; and selecting one job from among the set of jobs to be executed by the first system.

The scheduling program according to the present disclosure causes a computer to execute: an input process that receives input of processing times required, for each of multiple jobs in which a first processing by a first system and a second processing by a second system are executed in mutual repetition one or more times, for the first processing and the second processing for each job; and a schedule creation control process that controls processing to create a schedule based on the processing times, wherein, in the schedule creation control process, a set creation process is executed to create, among the multiple jobs, a set of jobs that can be processed by the first system without idle time, and a selection process is executed to select one job from among the set of jobs to be executed by the first system.

According to the present disclosure, it is possible to schedule jobs so that one system among multiple systems can be operated on a priority basis.

### BRIEF DESCRIPTION OF DRAWINGS

FIG. 1 is a block diagram showing an example configuration of a scheduling device according to one example embodiment of the present disclosure.

FIG. 2 is an explanatory diagram showing an example of processing performed by a hybrid computing system.

FIG. 3 is a flowchart showing an example of operation of the scheduling device.

FIG. 4 is an explanatory diagram showing a concrete example of operation of the scheduling device.

FIG. 5 is an explanatory diagram showing simulation results for a user-side evaluation index.

FIG. 6 is an explanatory diagram showing simulation results for a server-side evaluation index.

FIG. 7 is an explanatory diagram showing simulation results for a user-side evaluation index.

FIG. 8 is an explanatory diagram showing simulation results for a server-side evaluation index.

FIG. 9 is an explanatory diagram showing simulation results for a user-side evaluation index.

FIG. 10 is a block diagram showing an overview of the scheduling device according to the present disclosure.

FIG. 11 is a schematic block diagram showing a configuration of a computer according to at least one example embodiment.

### DETAILED DESCRIPTION OF THE INVENTION

First, the situation assumed in this disclosure is described. The scheduling device of the present disclosure is a device that schedules jobs executed by multiple systems. Here, as a specific situation, let us assume a hybrid computing system in which processing is performed in alternating repetition for a job consisting of multiple processes by two systems, a computer systems Q and a computer system C.

The scheduling device of the present disclosure schedules jobs so that, among computer systems Q and computer system C, computer system Q can be operated on a priority basis. An example of computer system Q is a quantum computer system, and an example of computer system C is a classical computer system.

To begin with, this disclosure will explain a situation in which one job is executed by computer system Q and computer system C. In this case, while computer system C is executing, computer system Q is in an idle state, and while computer system Q is executing, computer system C is in an idle state.

For example, it is assumed that computer system Q is a scarce computing resource, while computer system C is a relatively inexpensive computing resource. In such a case, from the perspective of the provider (server side) of this hybrid computing system, any idle time of computer system Q could be considered a waste of resources.

Moreover, in this situation, we consider the case where the server side charges fees based on usage of the hybrid computing system. The unit price for computer system Q would be assumed to be significantly higher than that for computer system C. If the necessary costs, such as power consumption, do not change significantly even in an idle state, it is reasonable for the server to charge for the time during computation on computer system C, i.e., the idle time (idle time) of computer system Q, at the unit price of computer system Q. On the other hand, from the perspective of resource users, being charged at the unit price of computer system Q for computation time on computer system C would feel expensive and might be a source of dissatisfaction.

The present disclosure assumes a situation in which multiple jobs are processed by the hybrid computing system, as a way to use the hybrid computing system efficiently. In other words, in this hybrid computing system, the idle time for computer system Q that could occur with a single job is filled by letting computer system Q process other jobs, thereby preventing computer system Q from remaining idle.

Furthermore, when multiple jobs are being executed, from the user's perspective, if one focuses only on the efficiency of computer system Q, there is a concern that processing time will be significantly longer than if computer system Q were exclusively used to execute a single job.

In other words, from the server side's perspective, running a large number of jobs is advantageous for reducing idle time of computer system Q, whereas from the user side's perspective, the selection of one job among many could negatively affect elapsed time. Thus, there is a trade-off between the two perspectives.

Because this issue is, in essence, a multi-objective optimization problem, there is no single correct solution, and a compromise between the server side and the user side is necessary. Therefore, as a method of prioritizing reduction in idle time for computer system Q while avoiding a multi-objective optimization problem, the present disclosure proposes a simple method of creating a schedule that suppresses the deterioration of elapsed time.

Below, example embodiments of the present disclosure will be explained with reference to the drawings.

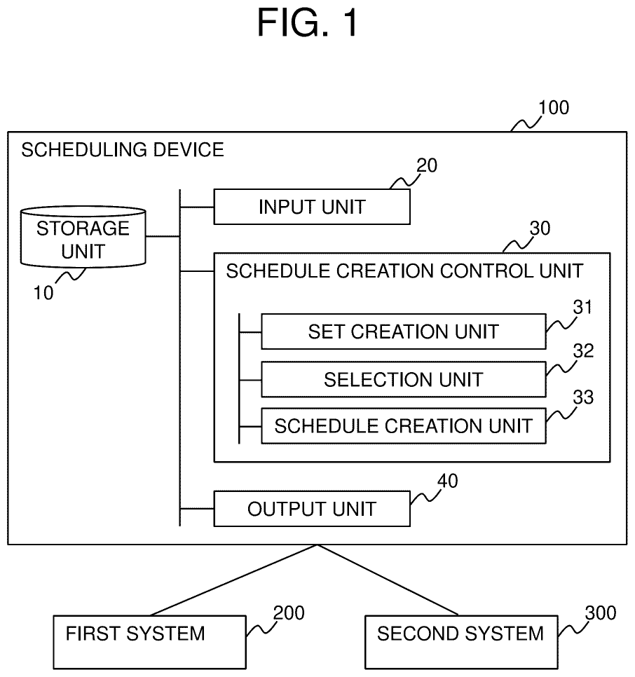

FIG. 1 is a block diagram showing an example configuration of a scheduling device according to one example embodiment of the present disclosure. The scheduling device 100 includes a storage unit 10, an input unit 20, a schedule creation control unit 30, and an output unit 40.

In the example shown in FIG. 1, the scheduling device 100 is connected to a first system 200 and a second system 300, which execute the created schedule. However, the first system 200 and the second system 300 need not be connected to the scheduling device 100.

The storage unit 10 stores various information used for processing by the scheduling device 100. For example, the storage unit 10 may be implemented by a magnetic disk or the like.

The input unit 20 receives input of the processing time required for each process of each of multiple jobs. In this example embodiment, a job is executed in mutual repetition one or more times first processing by the first system 200 (hereinafter simply called the first processing) and second processing by the second system 300 (hereinafter simply called the second processing).

In the above example, the first system 200 corresponds to the computer system Q, and the second system 300 corresponds to the computer system C. In the following explanation, for each job i, the processing time of the first processing is denoted as T_{Q}(i), and the processing time of the second processing is denoted as T_{C}(i).

Moreover, for simplicity, the first processing and the second processing may each require the same processing time. In this case, the input unit 20 may receive input of the processing time (T_{Q}(i), T_{C}(i)) required for each process (the first processing and the second processing) when the first process and the second process are repeated for each job, as well as the total number of repetitions N_{cyc}. In the following description, it is assumed that the first process and the second process all require the same processing time.

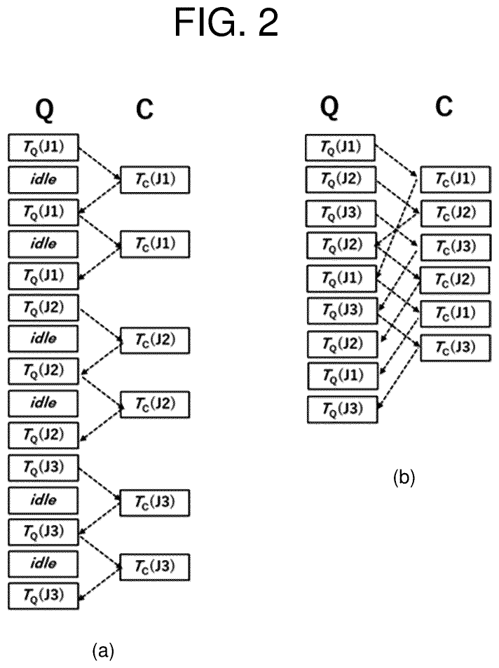

FIG. 2 is an explanatory diagram showing an example of processing performed by a hybrid computing system. The hybrid computing system showed in FIG. 2 is a system that processes a job by alternately executing processing on two systems, the computer system Q and the computer system C. Note that, in the following explanation, processing by the computer system Q (that is, the first processing) may sometimes simply be denoted as Q, and processing by the computer system C (that is, the second processing) may sometimes simply be denoted as C. Also, it is assumed that all jobs are simultaneously input to the computer system Q at a start time Tₛₜₐᵣₜ (=0).

In the example shown in FIG. 2, processing starts from the computer system Q, and a job is assumed in which the repeated “C->Q” processing is performed N_{cyc} times. For example, when N_{cyc}=1, the processing sequence becomes “Q->C->Q.” When N_{cyc}=3, the processing sequence becomes “Q->C->Q->C->Q->C->Q.”

If T_{Q} and T_{C}, respectively, represent the computation time for Q and C in each iteration (constant regardless of the number of iterations), then the total computation time Tₜₒₜ is expressed as Tₜₒₜ=(N_{cyc}+1)T_{Q}+N_{cyc}T_{C}. This Tₜₒₜ corresponds to the computation time when a job is processed in a dedicated mode on the hybrid computing system.

FIG. 2(a) shows an example of operation in which a job is executed in a dedicated mode on the hybrid computing system. In the example shown in FIG. 2(a), N_{cyc}=2 and the number of jobs n_{J}=3 (J_{S}={J₁, J₂, J₃}). As shown in FIG. 2(a), while the computer system C is computing, the computer system Q becomes idle, so it can be said that the computer system Q is in an inefficient situation.

On the other hand, FIG. 2(b) shows an example of operation when jobs are executed based on a schedule created by the method of the present disclosure on the hybrid computing system.

Because the present disclosure focuses on idle time of the computer system Q, it is assumed that the computer system C has a dedicated computing resource for each job. In other words, once processing by the computer system Q for a given job is completed, that job can immediately run on the computer system C. That is, because a single computer system Q processes n_{J} jobs, a queue can form for computer system Q. Meanwhile, because the computer system C performs processing with dedicated computing resources for each job, no queue forms there.

The example shown in FIG. 2(b) illustrates an example of operation in which another job is executed during the idle time of the computer system Q shown in FIG. 2(a). Note that, when the sequence “C->Q” is repeated, there may be cases in which the computer system Q becomes idle because none of the jobs have finished processing on the computer system C. The process for this situation will be explained later.

The schedule creation control unit 30 controls the processing to create a schedule based on the received processing times. The schedule creation control unit 30 includes a set creation unit 31, a selection unit 32, and a schedule creation unit 33.

The set creation unit 31 creates, based on the received processing times, a set J_{F} of jobs among the multiple jobs that can be processed by the first system without idle time. Note that the set J_{F} may contain multiple jobs or may be just one job.

Specifically, the set creation unit 31 extracts from among multiple jobs those jobs for which the processing by the computer system C is complete but the processing by the computer system Q is not yet complete, and creates the set J_{F} of these jobs. In this example embodiment, all jobs are assumed to be input simultaneously to the computer system Q at a start time Tₛₜₐᵣₜ (=0). Therefore, in the initial state, the set creation unit 31 creates the set J_{F} that contains all of the jobs to be executed.

As explained above, it is also assumed that there may be no jobs that can be processed immediately by the first system without idle time. That is, when the “C->Q” iteration is performed, it is also possible that the computer system Q becomes idle because processing on the computer system C has not finished. In such a case, the set creation unit 31 may create a set J_{F′} of jobs for which the first system processing remains unfinished. In the following explanation, such a set J_{F′} of jobs may also be referred to as a provisional set of jobs that can be executed.

The selection unit 32 selects one job from within the job set J_{F} to be executed by the first system. The method by which the selection unit 32 selects one job from among the job set may be arbitrary. The selection unit 32 may randomly select one job from the job set, or it may select one job that performs processing having the shortest processing time for the computer system Q. In addition, the method by which the selection unit 32 selects one job may be predetermined, or an input unit 20 may receive a method instruction from a user.

The schedule creation control unit 30 determines the order in which jobs will be processed by repeatedly executing processing by the set creation unit 31 and the selection unit 32 described above. Specifically, the schedule creation control unit 30 executes control that removes one job from the job set to create a new job set in the set creation unit 31, and executes control that selects one job from the new job set in the selection unit 32, repeating these processes.

Specifically, the set creation unit 31, at the time when preceding processing by the first system (the computer system Q) finishes and the first system becomes available, creates a new job set from among a job set J_{S}, composed of jobs that can be processed by the first system. In other words, the set creation unit 31 creates a new job set consisting of those jobs whose processing on the preceding computer system C has finished and that require no idle time. Then, the selection unit 32 selects one job from the new job set.

The schedule creation unit 33 creates a schedule in the order of the selected jobs. The schedule creation unit 33 may also calculate total processing time or idle time for the computer system Q from the created schedule.

Furthermore, the schedule creation control unit 30 may execute the schedule creation processing multiple times. For example, if the selection unit 32 randomly selects one job from among the job set, the schedule creation control unit 30 may select, from among multiple created schedules, the schedule having the smallest sum of idle times.

The output unit 40 outputs the created schedule. The manner in which the output unit 40 outputs the schedule is arbitrary. The output unit 40 may, for example, display the created schedule on a display device (not shown) or output it in a file format.

In addition, the output unit 40 may not only output the created result but also perform control for actually executing jobs according to the created schedule on each system (for example, the first system 200 and the second system 300).

The input unit 20, the schedule creation control unit 30 (more specifically, the set creation unit 31, the selection unit 32, and the schedule creation unit 33), and the output unit 40 are implemented by a processor (for example, a CPU (Central Processing Unit) or a GPU (Graphics Processing Unit)) of a computer that operates according to a program (a scheduling program).

For example, the program may be stored in the storage unit 10 of the scheduling device 100, the processor may read that program, and operate in accordance with the program as the input unit 20, the schedule creation control unit 30 (more specifically, the set creation unit 31, the selection unit 32, and the schedule creation unit 33), and the output unit 40. Also, the functions of the scheduling device 100 may be provided in a SaaS (Software as a Service) format.

Moreover, the input unit 20, the schedule creation control unit 30 (more specifically, the set creation unit 31, the selection unit 32, and the schedule creation unit 33), and the output unit 40 may each be implemented by dedicated hardware. Some or all components of each device may be implemented by general-purpose or dedicated circuitry, processors, or a combination thereof. They may be configured by a single chip or by multiple chips connected via a bus. Some or all components of each device may also be implemented by a combination of the circuitry described above and a program.

Furthermore, if some or all of the components of the scheduling device 100 are realized by multiple information processing devices or circuits, these multiple information processing devices or circuits may be centrally located or distributed. For example, the information processing devices or circuits may be connected via a communication network in a client-server system or a cloud computing system, among other configurations.

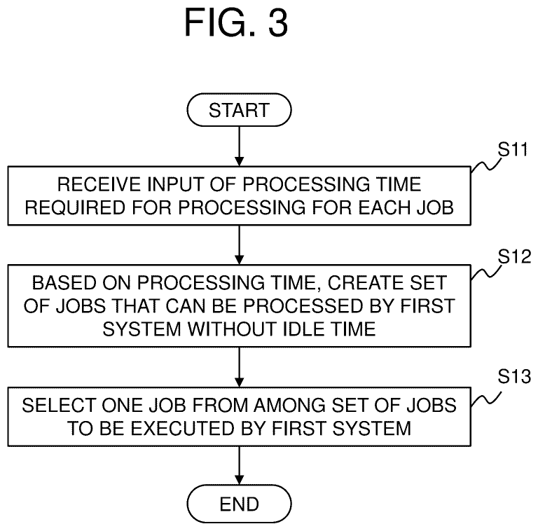

Next, an operation of this example embodiment of the scheduling device 100 will be explained. FIG. 3 is a flowchart showing an example of operation of the scheduling device 100 in this example embodiment. The input unit 20 receives input of the processing time required for the first processing and the second processing for each job (step S11). The set creation unit 31, based on the processing times, creates, among the multiple jobs, a set of jobs that can be processed by the first system without idle time (step S12). Then, the selection unit 32 selects one job from among the set of jobs to be executed by the first system (step S13).

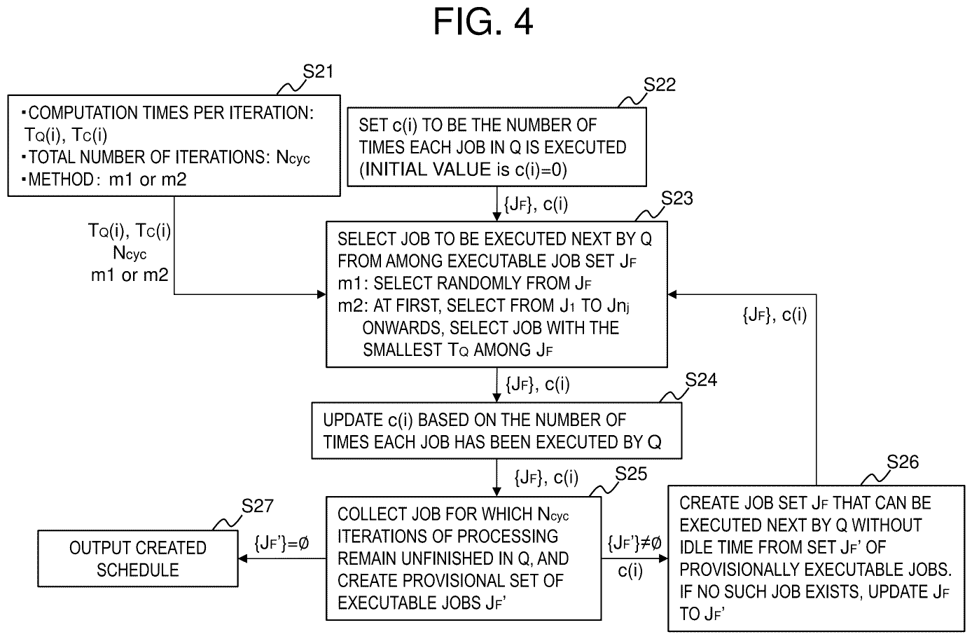

FIG. 4 is an explanatory diagram showing a concrete example of the operation of the scheduling device 100 in this example embodiment. Here, the input unit 20 receives the computation times T_{Q}(i) and T_{C}(i) per iteration, as well as the total number of iterations N_{cyc} (step S21). In this concrete example, the input unit 20 also receives input specifying the method (m1 or m2) for selecting a job. In the example shown in FIG. 4, m1 indicates a method of random selection, and m2 indicates a method of selecting the job having the shortest processing time.

The schedule creation control unit 30 sets a processing counter c(i). In the initial state, c(i)=0. Also, the set creation unit 31 sets a job set J_{F} to be executed (step S22).

The selection unit 32 selects a job to be executed next by the computer system Q from among the executable job set J_{F} (step S23). If method m1 is input, the selection unit 32 randomly selects a job from J_{F}. If method m2 is input, then for the first time, the selection unit 32 selects any job from among J₁ to Jₙⱼ, and thereafter selects, among J_{F}, the job with the smallest T_{Q}.

The schedule creation control unit 30 updates the processing counter c(i) based on the number of times each job has been executed by the computer system Q (step S24). Subsequently, the set creation unit 31 collects jobs for which N_{cyc} iterations of processing remain unfinished in the computer system Q, and creates a provisional set of executable jobs J_{F′} (step S25).

Then, the set creating section 31 creates a job set J_{F} of jobs that can be executed next by the computer system Q without idle time from the set J_{F′} of provisionally executable jobs. On the other hand, if no such job exists, the set creation unit 31 updates J_{F} to J_{F′} (step S26). Thereafter, the processing from step S23 onward repeats, and when no jobs remain in J_{F′}, the schedule creation unit 33 creates a schedule, and an output unit 40 outputs the created schedule (step S27).

As described above, in this example embodiment, the input unit 20 receives input of the processing times required for the first processing and the second processing for each job, and the set creation unit 31, based on the processing times, creates, among the multiple jobs, a set of jobs that can be processed by the first system without idle time. Then, the selection unit 32 selects one job from among the set of jobs to be executed by the first system. Thus, it is possible to schedule jobs so that one system (the first system) among multiple systems can be operated on a priority basis.

Next, the efficiency of a hybrid computing system when using the scheduling device 100 of the present disclosure will be explained. Two perspectives are assumed to evaluate the efficiency of the hybrid computing system: one on the server side and one on the user side. First, an evaluation index Eₛ for the server side was employed as shown in Equation 1 below.

$$\begin{matrix}[ Math . 1 ] & \\ {E}_{S} = \frac{( {T}_{end} - ( {N}_{cyc} + 1 ) {\sum }_{i = 1}^{{n}_{j}} {T}_{Q} ( i ) )}{{T}_{end}} & ( Equation 1 )\end{matrix}$$

In Equation 1, T_{end} represents a time from a start (Tₛₜₐᵣₜ=0) until processing of all n_{J} jobs is completed, and T_{Q}(i) represents a processing time of job i in the computer system Q during each iteration. (N_{cyc}+1)Σᵢ₌₁^{nj} T_{Q}(i) is the time required, from the start until processing of all n_{J} jobs is completed, under the condition of zero idle time. Therefore, E_{S} represents a ratio of the idle time within the actual total processing time.

On the other hand, for an evaluation index E_{U} on the user side, two types of values were considered. One is an average value (Rₑ^{M}) of the ratio (Rₑ(i)) between the elapsed time of job i under a multi-job condition and the elapsed time of job i in a dedicated mode. The other is Rew, a worst value of the elapsed times of n_{J} jobs, because the more jobs there are, the longer the elapsed time is likely to become, possibly making some users wait a very long time. Rₑ(i) is expressed by Equation 2 shown below.

$$\begin{matrix}[ Math . 2 ] & \\ {R}_{e} ( i ) = \frac{{T}_{E} ( i ) - {T}_{S} ( i )}{( {N}_{cyc} + 1 ) {T}_{Q} ( i ) + {N}_{cyc} {T}_{Q} ( i )} & ( Equation 2 )\end{matrix}$$

Here, T_{E}(i) and T_{S}(i) are respectively a completion time and a start time of a job i. However, in this concrete example, because all jobs are assumed to be submitted simultaneously at time 0, T_{S}(i)=0. In addition, T_{Q}(i) and T_{C}(i) are computation times of job i on the computer system Q and the computer system C during each repeated process (here, T_{Q}(i) and T_{C}(i) do not depend on the number of iterations and are fixed per job). RₑM and RₑW are given by Equation 3 shown below.

$$\begin{matrix}[ Math . 3 ] & \\ {R}_{e}^{M} = \frac{1}{{n}_{j}} {\sum }_{i = 1}^{{n}_{j}} {R}_{e} ( i ) , & ( Equation 3 )\end{matrix}$$

$${R}_{e}^{W} = {max}_{i} {R}_{e} ( i )$$

An example in which these indices are used will be explained.

### EXAMPLE

Although this disclosure will be explained below by referring to concrete examples, the scope of the invention of the present disclosure is not limited to the content described below.

### <Example 1> Determining Criteria for Selection that Evaluation Index E_{U} on a User-Side has Good

When selecting, in the computer system Q, which job to process next from among an executable job set, the following four criteria can be considered:
(1) select the job whose T_{Q}(i) is smallest (Qₘᵢₙ);
(2) select the job whose T_{Q}(i) is largest (Qₘₐₓ);
(3) select the job whose T_{C}(i) is smallest (Cₘᵢₙ); and
(4) select the job whose T_{C}(i) is largest (Cₘₐₓ).

This is a type of greedy method, but it is easily influenced by the job selected first. Therefore, only when selecting a job for the first time, all nⱼ jobs were exhaustively checked, and for the second and subsequent times, one of the four criteria above was used to select a job.

In order to perform a specific numerical simulation, it is necessary to set several parameter values. First, nⱼ=5 and N_{cyc}=3 for nⱼ and N_{cyc} were chosen. As explained below, these values were found to be a combination that yields typical results in this simulation.

Furthermore, T_{Q}(i) and T_{C}(i) were set by uniformly sampling random numbers from the interval [0,1]. However, a single sampling may result in an extremely biased outcome. Therefore, 10 sets of jobs (T_{Q}(i) and T_{C}(i)) were prepared.

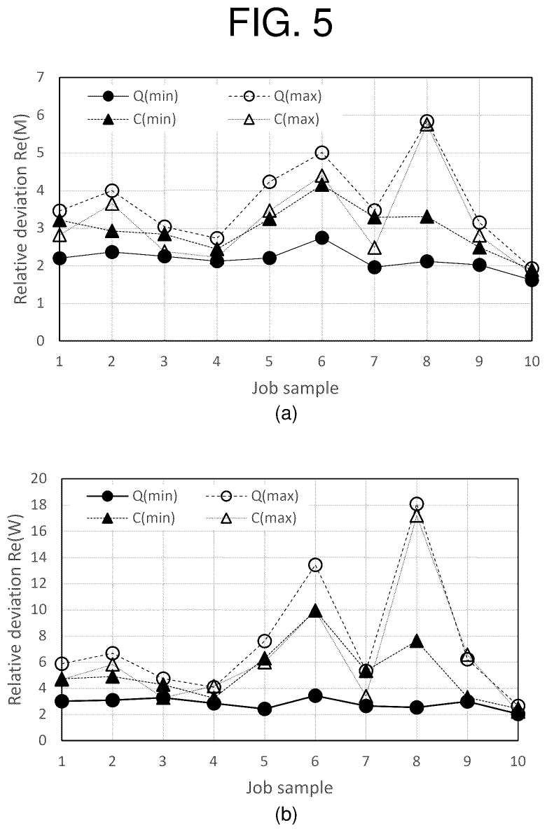

FIG. 5 is an explanatory diagram showing simulation results for a user-side evaluation index E_{U}. The graphs illustrated in FIG. 5 show the simulation results of the average (Rₑ^{M}) (FIG. 5(a)) and worst-case values (Rₑ^{W}) (FIG. 5(b)) of the elapsed time of nⱼ jobs for 10 job sets as the user-perspective evaluation index E_{U} described above. In the case of Qₘᵢₙ, both Rₑ^{M} and Rew reach a consistently low value that does not strongly depend on the job set.

As will be described later, the Cₘₐₓ, which yielded good results in E_{S}, required an average elapsed time of more than 5 times that of the dedicated mode, and in the worst case, required an elapsed time of more than 15 times the elapsed time, which is undesirable from the E_{U} perspective. Therefore, we decided to adopt Qₘᵢₙ as the method that yields a favorable user-side evaluation index E_{U}. When computing the average value of E_{S} across the 10 sets in that case, we obtained the following results:

$${C}_{max} ( 0.033 ) < {Q}_{min} ( 0.083 ) < {Q}_{max} ( 0.100 ) < {C}_{min} ( 0.112 )$$

Among these four criteria, Qₘᵢₙ was judged to be the second best (with shorter idle time) also with respect to E_{S}.

### <Example 2> Determining Criteria for Selection that Evaluation Index E_{S} on a Server-Side has Good

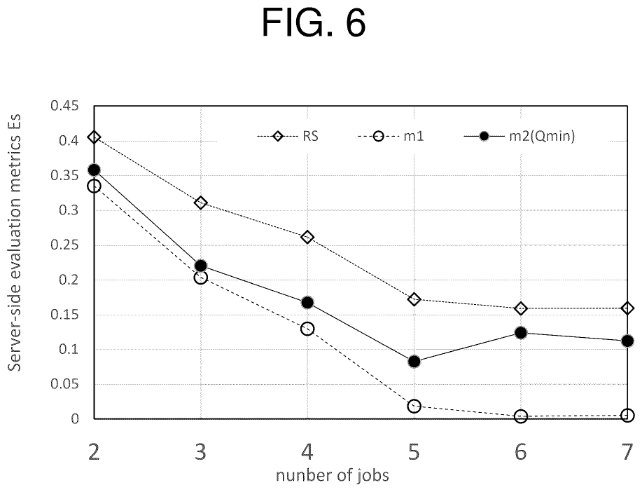

In Example 2, we investigated how E_{S} and E_{U} depend on nⱼ. FIG. 6 is an explanatory diagram showing simulation results for the server-side evaluation index E_{S}. Specifically, the graph illustrated in FIG. 6 shows the behavior of E_{S} when nⱼ is changed from 2 to 7.

In FIG. 6, m1 indicates the case where the next job is randomly selected from among the executable job set in each processing in the computer system Q. However, for comparison with method m2 (which exhaustively checks only the first selection), we attempted nⱼ times and chose the best result. Method m2 is the method that selects the next job to be processed from the executable job set using the criterion Qₘᵢₙ determined in Example 1.

In addition, as a benchmark for these methods, RS is shown, in which no consideration is given to idle time and the processing sequence is determined randomly from the beginning. For consistency with the comparison with method m2, regarding RS, we also attempted nⱼ sequences and chose the best result. The y-axis in FIG. 6 indicates the value of E_{S}, and the graph shows the average across the same 10 job sets used in FIG. 5. Until nⱼ=5, E_{S} decreases sharply for RS, m1, and m2 (Qₘᵢₙ), but the change becomes relatively moderate thereafter. Therefore, we consider that increasing the number of jobs beyond nⱼ=5 does not have a large effect. Moreover, in the case of m1 at nⱼ=5, the idle time can be reduced to almost zero (1.8%), which is better than the 3.3% achieved by m2 (Cₘₐₓ), which was the best with respect to E_{S} in Example 1. Therefore, we chose a method in which the next job is randomly selected from a set of executable jobs in each processing of m1 on the computer system Q, as a method with a good server-side evaluation index E_{S}.

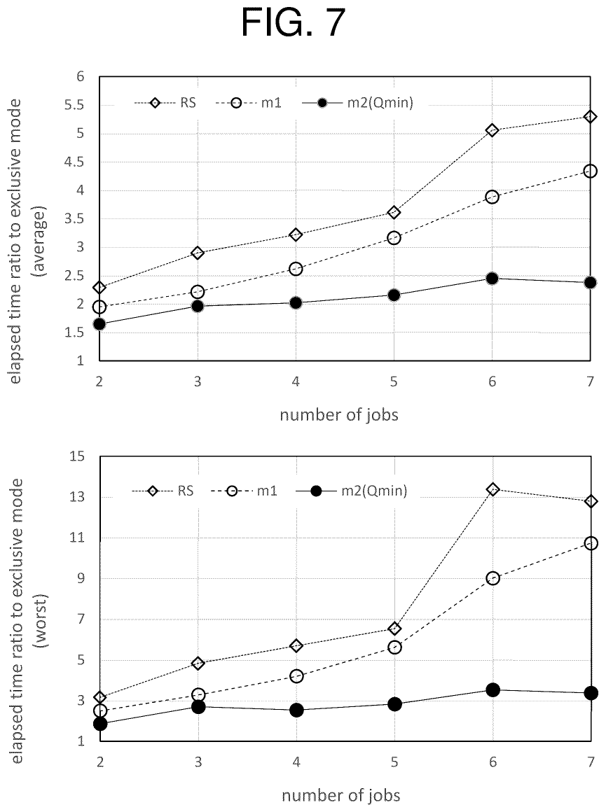

However, m1 tends to worsen the user-side evaluation index E_{U}. FIG. 7 is an explanatory diagram showing simulation results for the user-side evaluation index E_{U}. In particular, the graph in FIG. 7 shows how E_{U} behaves when nⱼ is changed from 2 to 7, indicating the average of the same 10 job sets used in FIG. 6. Thus, FIG. 7(a) shows the average value (Rₑ^{M}) of the elapsed time for nⱼ jobs, and FIG. 7(b) shows the worst value (Rₑw) of the elapsed time for nⱼ jobs.

In the case of m2 (Qₘᵢₙ), the increase (deterioration) in elapsed times is relatively moderate even when nⱼ increases, whereas with RS and m1, the increase in elapsed times is significant. In particular, for RS, the elapsed time deteriorates sharply once nⱼ exceeds 5.

### <Example 3> Stability of the Proposed Method

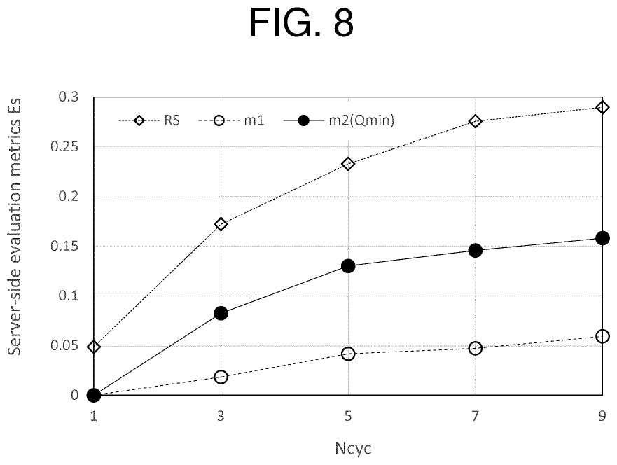

To examine the stability of the proposed method, we investigated how N_{cyc} influences E_{S} and E_{U}. FIG. 8 is an explanatory diagram showing simulation results for a server-side evaluation index E_{S}. Specifically, the graph in FIG. 8 shows how E_{S} behaves when N_{cyc} is changed to 1, 3, 5, 7, and 9, indicating the average of the 10 job sets. For RS, m1, and m2 (Qₘᵢₙ), idle time tends to increase as N_{cyc} increases, although the rate of increase is smaller.

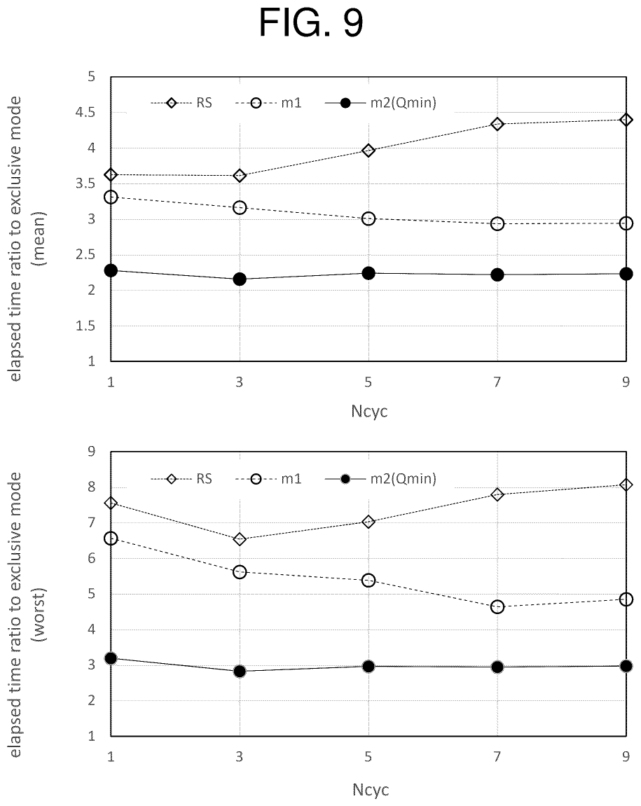

FIG. 9 is an explanatory diagram showing simulation results for a user-side evaluation index E_{U}. The graph in FIG. 9 shows how E_{U} behaves when N_{cyc} is changed to 1, 3, 5, 7, and 9. In both the average elapsed time illustrated in FIG. 9(a) and the worst elapsed time illustrated in FIG. 9(b), as a general trend, RS tends to increase as N_{cyc} increases, and m1 shows a slight tendency to decrease as N_{cyc} increases.

By contrast, m2 (Qₘᵢₙ) remains almost constant without showing strong dependence on N_{cyc}. In this case, even the worst value is only around three times, which suggests it is a desirable scheduling approach. Also, m1, which shows about three times in the average and five times in the worst, could be considered desirable scheduling from the user's perspective as well.

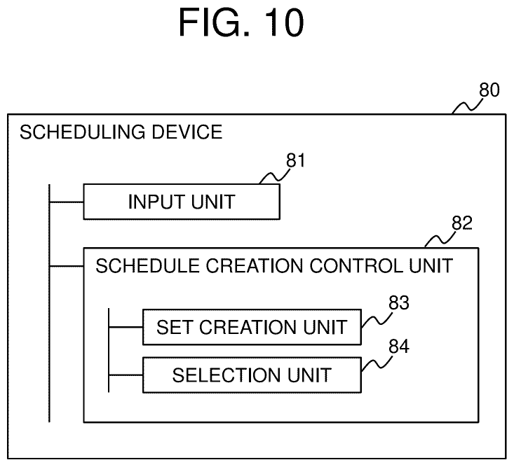

Next, an overview of the present disclosure will be explained. FIG. 10 is a block diagram showing an overview of the scheduling device according to the present disclosure. The scheduling device 80 (for example, the scheduling device 100) according to the present disclosure includes an input unit 81 (for example, the input unit 20) configured to receive input of processing times required, for each of multiple jobs in which a first processing by a first system (for example, the computer system Q) and a second processing by a second system (for example, the computer system C) are executed in mutual repetition one or more times, for the first processing and the second processing for each job, and a schedule creation control unit 82 (for example, the schedule creation control unit 30) configured to control processing to create a schedule based on the processing times.

The schedule creation control unit 82 includes a set creation unit 83 (for example, the set creation unit 31) configured to create, among the multiple jobs, a set of jobs that can be processed by the first system without idle time, and a selection unit 84 (for example, the selection unit 32) configured to select one job from among the set of jobs to be executed by the first system.

With such a configuration, it is possible to schedule jobs so that one system among multiple systems can be operated on a priority basis.

Specifically, the selection unit 84 may randomly select one job from among the set of jobs.

In that case, the schedule creation control unit 82 may execute processing to create the schedule multiple times and select the schedule having the smallest total idle time.

On the other hand, the selection unit 84 may select one job, among the set of jobs, that performs the first processing having the shortest processing time in the first system.

Moreover, if there exists no job that can be processed by the first system without idle time, the set creation unit 83 may create a set of jobs for which processing by the first system remains unfinished, and the selection unit 84 may select one job from the set of jobs.

Additionally, the schedule creation control unit 82 may repeatedly execute: control that causes the set creation unit 83 to create a new set of jobs by removing one job from the set of jobs; and control that causes the selection unit 84 to select one job from among the new set of jobs.

Furthermore, the schedule creation control unit 82 may include a schedule creation unit (for example, the schedule creation unit 33) that creates the schedule in the order of selected jobs.

Additionally, the input unit 81 may receive input of the processing times required for the first processing and the second processing for each job and the total number of iterations for each job.

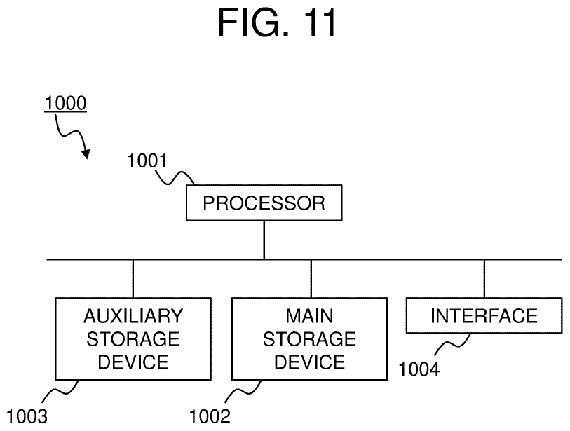

FIG. 11 is a schematic block diagram showing a configuration of a computer 1000 according to at least one example embodiment. The computer 1000 includes a processor 1001, a main storage device 1002, an auxiliary storage device 1003, and an interface 1004. Also, the computer 1000 may be connected to another computer that executes a mathematical programming solver, an annealing machine, a simulator, or the like.

The scheduling device 80 described above is implemented on the computer 1000. The operations of each of the processing units described above are stored, in the form of a program (scheduling program), in the auxiliary storage device 1003. The processor 1001 reads the program out of the auxiliary storage device 1003, deploys it in the main storage device 1002, and executes the processing in accordance with that program.

In at least one example embodiment, the auxiliary storage device 1003 is one example of a non-transitory tangible medium. Other examples of non-transitory tangible media include a magnetic disk, a magneto-optical disk, a CD-ROM (Compact Disc Read-only Memory), a DVD-ROM (Read-only Memory), or a semiconductor memory, all of which may be connected via the interface 1004. When the program is delivered to the computer 1000 via a communication line, the computer 1000 receiving the delivery may deploy that program in the main storage device 1002 and execute the above processing.

Moreover, the program may be intended to implement only part of the functions described above. Furthermore, the program may be a so-called difference file (difference program) that implements the functions described above in combination with another program already stored in the auxiliary storage device 1003.

Some or all of the example embodiments described above may also be described as follows, but are not limited thereto.

(Supplementary Note 1) A scheduling device comprising: an input unit configured to receive input of processing times required, for each of multiple jobs in which a first processing by a first system and a second processing by a second system are executed in mutual repetition one or more times, for the first processing and the second processing for each job; and a schedule creation control unit configured to control processing to create a schedule based on the processing times, wherein the schedule creation control unit includes: a set creation unit configured to create, among the multiple jobs, a set of jobs that can be processed by the first system without idle time; and a selection unit configured to select one job from among the set of jobs to be executed by the first system.

(Supplementary Note 2) The scheduling device according to Supplementary Note 1, wherein the selection unit randomly selects one job from among the set of jobs.

(Supplementary Note 3) The scheduling device according to Supplementary Note 2, wherein the schedule creation control unit executes processing to create the schedule multiple times and selects the schedule having the smallest total idle time.

(Supplementary Note 4) The scheduling device according to Supplementary Note 1, wherein the selection unit selects one job, among the set of jobs, that performs the first processing having the shortest processing time in the first system.

(Supplementary Note 5) The scheduling device according to any one of Supplementary Notes 1 to 4, wherein the set creation unit creates a set of jobs for which processing by the first system remains unfinished, if there exists no job that can be processed by the first system without idle time, and the selection unit selects one job from among the set of jobs.

(Supplementary Note 6) The scheduling device according to any one of Supplementary Notes 1 to 4, wherein the schedule creation control unit repeatedly executes: control that causes the set creation unit to create a new set of jobs by removing one job from the set of jobs; and control that causes the selection unit to select one job from among the new set of jobs.

(Supplementary Note 7) The scheduling device according to any one of Supplementary Notes 1 to 4, wherein the schedule creation control unit includes a schedule creation unit that creates the schedule in order of selected jobs.

(Supplementary Note 8) The scheduling device according to any one of Supplementary Notes 1 to 4, wherein the input unit receives input of the processing times required for the first processing and the second processing for each job and the total number of iterations for each job.

(Supplementary Note 9) The scheduling device according to any one of Supplementary Notes 1 to 8, further comprising an output unit configured to output the created schedule.

(Supplementary Note 10) A scheduling method comprising: receiving input of processing times required, for each of multiple jobs in which a first processing by a first system and a second processing by a second system are executed in mutual repetition one or more times, for the first processing and the second processing for each job; based on the processing times, creating, among the multiple jobs, a set of jobs that can be processed by the first system without idle time; and selecting one job from among the set of jobs to be executed by the first system.

(Supplementary Note 11) A scheduling program for causing a computer to execute: an input process that receives input of processing times required, for each of multiple jobs in which a first processing by a first system and a second processing by a second system are executed in mutual repetition one or more times, for the first processing and the second processing for each job; and a schedule creation control process that controls processing to create a schedule based on the processing times, wherein, in the schedule creation control process, a set creation process is executed to create, among the multiple jobs, a set of jobs that can be processed by the first system without idle time, and a selection process is executed to select one job from among the set of jobs to be executed by the first system.

While the present disclosure has been explained with reference to the example embodiments and examples, the present disclosure is not limited to these example embodiments and examples. Various modifications can be made to the configuration and details of the present invention within the scope of the present disclosure as understood by those skilled in the art.

1. A scheduling device comprising:
a memory storing instructions; and
one or more processors configured to execute the instructions to:
receive input of processing times required, for each of multiple jobs in which a first processing by a first system and a second processing by a second system are executed in mutual repetition one or more times, for the first processing and the second processing for each job; and
control processing to create a schedule based on the processing times,
wherein the processor is configured to execute the instructions to:
create, among the multiple jobs, a set of jobs that can be processed by the first system without idle time; and
select one job from among the set of jobs to be executed by the first system.

2. The scheduling device according to claim 1, wherein the processor is configured to execute the instructions to randomly select one job from among the set of jobs.

3. The scheduling device according to claim 2, wherein the processor is configured to execute the instructions to execute processing to create the schedule multiple times and selects the schedule having the smallest total idle time.

4. The scheduling device according to claim 1, wherein the processor is configured to execute the instructions to execute select one job, among the set of jobs, that performs the first processing having the shortest processing time in the first system.

5. The scheduling device according to claim 1, wherein the processor is configured to execute the instructions to:
create a set of jobs for which processing by the first system remains unfinished, if there exists no job that can be processed by the first system without idle time; and
select one job from among the set of jobs.

6. The scheduling device according to claim 1, wherein the processor is configured to execute the instructions to repeatedly execute:
control that causes the set creation unit to create a new set of jobs by removing one job from the set of jobs; and
control that causes the selection unit to select one job from among the new set of jobs.

7. The scheduling device according to claim 1, wherein the processor is configured to execute the instructions to create the schedule in order of selected jobs.

8. The scheduling device according to claim 1, wherein the processor is configured to execute the instructions to receive input of the processing times required for the first processing and the second processing for each job and the total number of iterations for each job.

9. A scheduling method comprising:
receiving input of processing times required, for each of multiple jobs in which a first processing by a first system and a second processing by a second system are executed in mutual repetition one or more times, for the first processing and the second processing for each job;
based on the processing times, creating, among the multiple jobs, a set of jobs that can be processed by the first system without idle time; and
selecting one job from among the set of jobs to be executed by the first system.

10. A non-transitory computer readable information recording medium storing a scheduling program, when executed by a processor, that performs a method for:
receiving input of processing times required, for each of multiple jobs in which a first processing by a first system and a second processing by a second system are executed in mutual repetition one or more times, for the first processing and the second processing for each job;
based on the processing times, creating, among the multiple jobs, a set of jobs that can be processed by the first system without idle time; and
selecting one job from among the set of jobs to be executed by the first system.
